(19) United States
(12) Patent Application Publication
(10) Pub. No.: US 2005/0284855 A1
(43) Pub. Date: Dec. 29, 2005

(54) Portable concession advertising and display apparatus

(76) Inventors: Gary Thyer, Leawood, KS (US); John Sherley, Lee's Summit, MO (US)

Correspondence Address: LATHROP & GAGE LC, 2345 GRAND AVENUE, SUITE 2800, KANSAS CITY, MO, 64108, US

(21) Appl. No.: 10/844,280

(22) Filed: May 12, 2004

(51) Int. Cl. H05B 1/00

(52) U.S. Cl. 219/214

(57) ABSTRACT

A portable concession advertising and display apparatus is provided for enhancing the overall concession purchasing experience in a movie theatre environment by moving the display of individually packaged concession items from behind a stationary glass counter and out into the movie theatre lobby area so that theatre goers are able to physically touch the concessions. The portable concession display apparatus is also useful in delineating a queuing area for the purchase of concession items and suitable for displaying bottled beverages and individually packaged concession items. One preferred embodiment of the portable concession display apparatus incorporates a refrigerated storage container area suitable for displaying bottled beverages for purchase. Another preferred embodiment incorporates and storage container area suitable for displaying bottled beverages on ice for purchase. All preferred embodiments include structures that facilitate the placement and display of both movie theatre and concession provider advertising on the portable concession display apparatus.

### FIELD OF INVENTION

The present invention generally relates to retailing fixtures, and more particularly to a portable concession display apparatus suitable for displaying both bottled beverages and individually packaged concession items in a concession stand environment.

### BACKGROUND OF THE INVENTION

Movie theatre consumers often arrive at the movie theatre premises shortly before the scheduled showing of the movie in which they are interested. These consumers typically wish to view the movie previews and purchase concessions within this short time frame. Depending upon the popularity of the movie and of the theatre generally, this time period often does not allow a consumer to accomplish all of these tasks. To ensure timely arrival in the movie auditorium to watch the previews, consumers may forego concession purchases altogether or, alternatively, miss a portion of the previews.

In addition, the movie theatre lobby is often structured as a large open space. The concessions typically are provided at a long counter at one or more ends of this space. In this environment, it is often difficult for consumers to determine the end of any specific queue for the purchase of concessions. Typically, movie theatre concessions are offered by the consumer talking to the concession staff and the staff personel gathering the requested items. Moreover, for some of the concession items, candy items in particular, the consumer cannot see the selection until the consumer reaches the concession stand. If a consumer is to make the decision to purchase concessions, they wish to move through the concession queue quickly. But this is hindered by a consumer's inability to find the end of a queue and, in addition, the inefficiency represented by the consumer's waiting on concession staff to take an order, fill a cup and return to the counter to obtain payment from the consumer.

For movie theatre operators, the purchase of concessions is a highly valued profit center. Thus, improvement in the efficiency of the concession area is desirable. This improvement may be accomplished by moving the display of concessions from behind the glass counter, and allow consumers to choose and hold purchases while queued. Enhancing the overall concession purchasing experience in this fashion will be valuable to both the movie theatre operator and to the consumer.

### SUMMARY OF THE INVENTION

The present invention seeks to enhance the overall concession purchasing experience in a movie theatre environment by moving the display of individually packaged concession items from behind a stationary glass counter and instead, providing a movable concession display rack useful in delineating a queuing area for the purchase of concession items and suitable for displaying bottled beverages and individually packaged concession items. One preferred embodiment of the movable concession display unit incorporates a refrigerated storage container area suitable for displaying bottled beverages for purchase. Another preferred embodiment incorporates and storage container area suitable for displaying bottled beverages on ice for purchase.

### BRIEF DESCRIPTION OF THE DRAWINGS

FIG. 1 is a perspective view of a movable concession display unit;

FIG. 2 is a top view of a movable concession display unit;

FIG. 3 is a side view of a movable concession display unit;

FIG. 4 is a bottom view of a movable concession display unit;

FIG. 5 is a rear view of a movable concession display unit; and

FIG. 6 is a front view of one disclosed embodiment of a movable concession display unit.

### DETAILED DESCRIPTION OF THE PREFERRED EMBODIMENTS

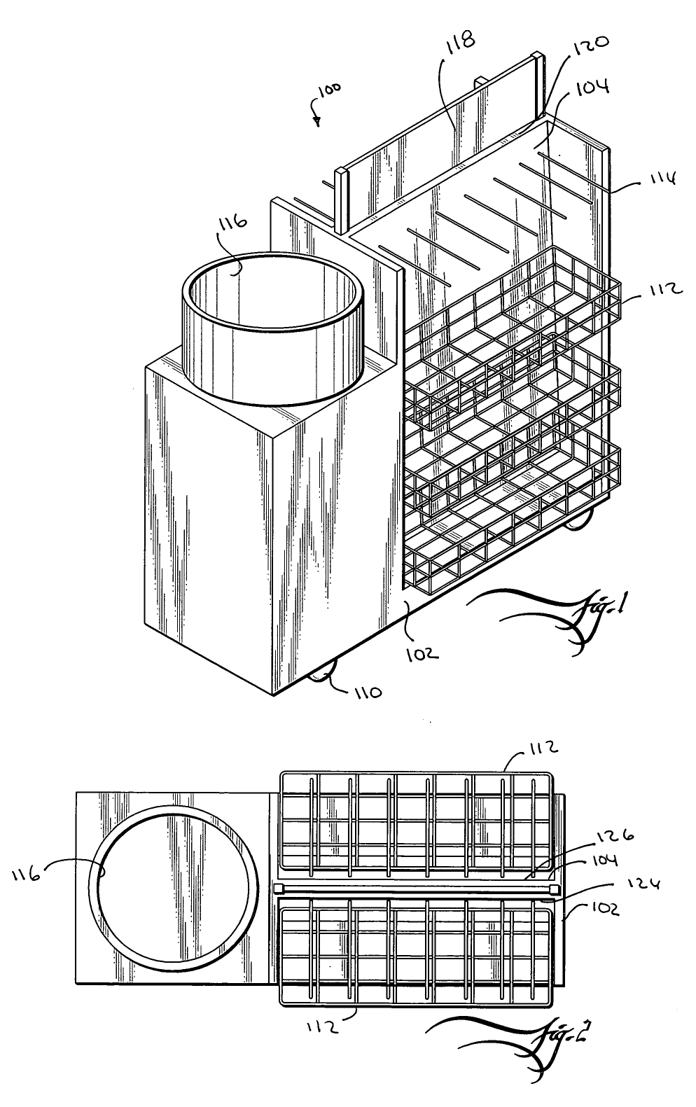

With reference to FIG. 1 the number 100 designates generally the concession display apparatus in accordance with the present invention. The apparatus 100 comprises a base 102 having a set of casters 110, a riser 104 extending vertically upward from the base 102, and a storage compartment 116.

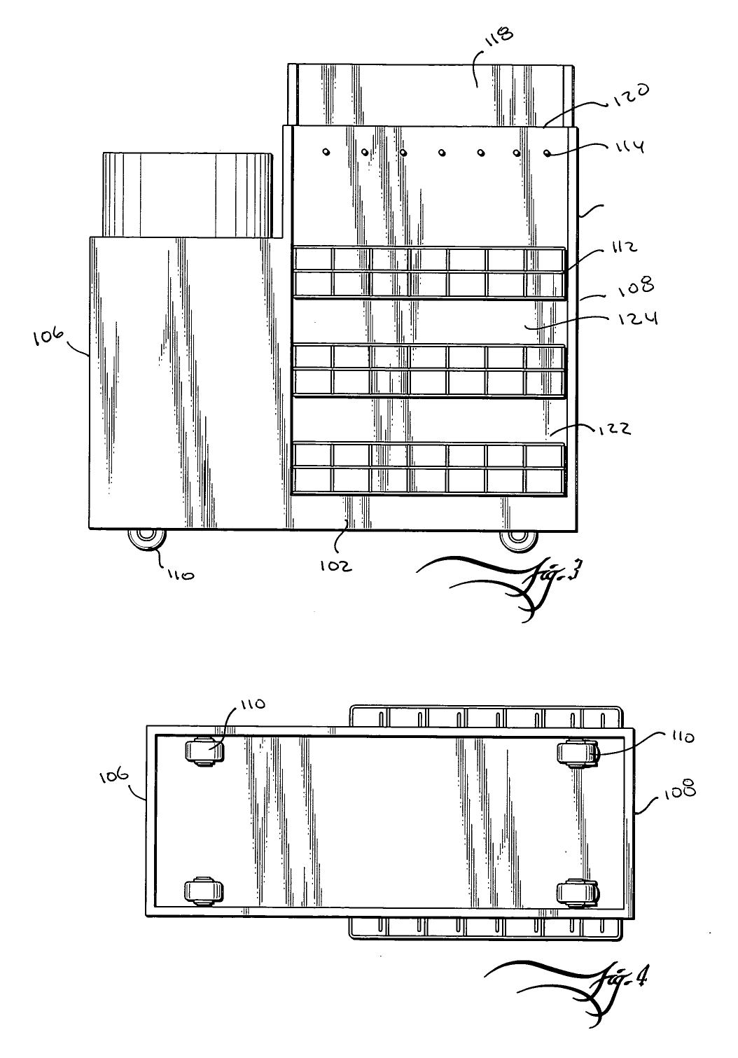

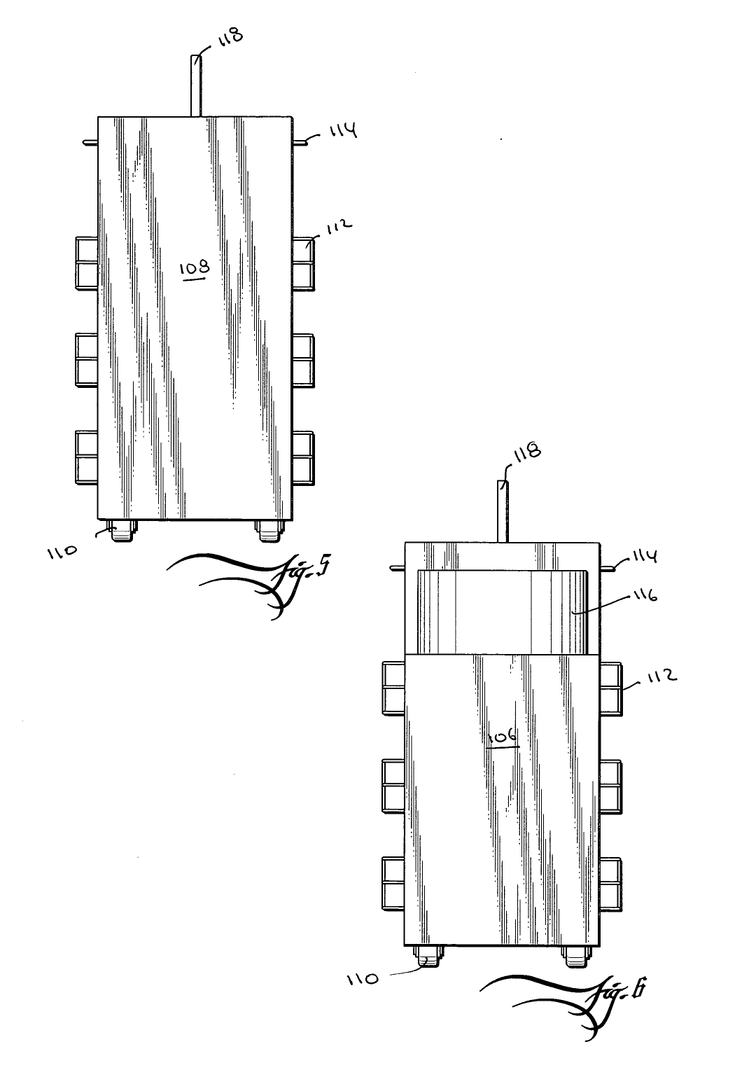

The base 102 is optimally rectangular in shape and is of solid construction sufficient to support the storage compartment 116. As will be understood by those skilled in the art, the base may be of any dimension, but should have a longitudinal length that will enable the apparatus to serve its queuing function as will be discussed in detail hereinafter. As shown in FIG. 3, multidirectional casters 110 are mounted to the bottom surface of base 102. FIG. 4 shows the bottom of the movable concession display apparatus 100 having four multidirectional casters 110 placed at the corners of the base 102. The casters enable the concession display apparatus 100 to be portable so that the apparatus can be moved adjacent a stationary concession counter located within a movie theater.

A storage department 116 is mounted to or integrally formed with base 102. An exemplary embodiment of the storage department of the concession display apparatus 100 is shown in the Figures. The storage department 116 includes a generally cylindrically or hemispherically shaped compartment for the display of bottled beverages. This compartment provides for easy selection and removal of the bottled or canned beverages from the storage compartment 116. It is to be understood that the storage department may be refrigerated to cool the beverages or alternatively may be constructed to be water tight and able to contain ice to cool the displayed bottled beverages.

The riser 104 of the concession display apparatus is integrally formed with or mounted to the base 102 at a bottom portion 122 of the riser. The riser extends upwardly from the base and comprises a generally planar front surface 124 and rear surface 126. Each of the riser front surface 124 and the riser back surface 126 are configured to have mounting means to enable the attachment of baskets 112, hooks 114 or a combination thereof. Preferably, the baskets and hooks are removably affixed to the riser for enabling a varied display of individually packaged concession items. Preferably and as is well known in the art, the front and back surface are configured with a series of holes that receive mounting hooks from the baskets and hooks. It is to be understood that any other suitable means may be used for displaying individually packaged concession items and the baskets and hooks may be integrally formed with the risers.

The riser 104 further comprises a first end 106 and a second end 108. Preferably, the second end of the riser is substantially planar. As such, the concession display apparatus can abut a concession stand with the second end 108 abutting the exterior wall of a concession stand.

As shown in FIG. 2, the top 120 of the concession display unit 100 is configured to receive an advertising frame 118 useful in displaying graphics or other signage.

It is to be understood that while certain forms of the present invention have been illustrated and described herein, it is not to be limited to the specific forms or arrangement of parts described and shown.

1. A concession display apparatus, the concession display apparatus being movable into an abutting relationship with a theatre concession stand and extending outwardly from a theatre concession stand, the apparatus comprising:
a base having at least one caster,
a riser extending vertically upward from the base and having front and rear surfaces, and first and second end walls, one of said first and second wall being operably configured to abut the theatre concession stand; each of the first and second walls placed at a 90 degree angle to the riser, the second wall is operably configured to abut the movie theatre concession stand, and
a storage compartment suitable for displaying bottled beverages operably configured to abut the first wall.

2. The concession display apparatus of claim 1 where the base is rectangular.

3. The concession display apparatus of claim 2 where the base has four multidirectional casters and wherein the concession display apparatus is portable.

4. The concession display apparatus of claim 2 wherein the apparatus further comprises a concession item holder and wherein at least one of the front and rear surfaces has means for receiving the concession item holder.

5. The movable concession display unit of claim 4 where the riser has a graphics frame removably attached to the top of the riser.

6. The movable concession display unit of claim 1 where the storage compartment is suitable for displaying bottled beverages with ice.

7. The movable concession display unit of claim 1 where the storage compartment is refrigerated.

8. A method of queuing movie theatre concession purchasers comprising the steps of:
providing one or more movable concession display apparatus,
arranging one or more movable concession display apparatus substantially at a 90 degree angle from a stationary concession stand so that the movable concession display apparatus abuts the stationary concession stand, the concession display apparatus extending longitudinally outwardly from the concession stand, and
providing one or more concession staff to accept payment for concession purchases made by movie theatre concession customers queued along the longitudinal edge of the movable concession display unit.
